(19) United States
(12) Patent Application Publication
(10) Pub. No.: US 2018/0276928 A1
(43) Pub. Date: Sep. 27, 2018

(54) HOTEL FACILITY, SYSTEM AND METHOD

(71) Applicant: MOBOXI, Dilsen-Stokkem (BE)

(72) Inventor: Peter Marcel SMEETS, Dilsen-Stokkem (BE)

(21) Appl. No.: 15/763,199

(22) PCT Filed: Sep. 28, 2015
(86) PCT No.: PCT/EP2015/072282

§ 371 Date: Mar. 26, 2018

(51) Int. Cl. G07C 9/00; G06Q 10/02; G06Q 50/12

(52) U.S. Cl. CPC G07C 9/00904; G07C 9/00166; G06Q 50/12; G06Q 10/02

(57) ABSTRACT

Hotel facility, system and method in which the time between arrival of a guest at the facility and entry of the guest into the hotel room is optimized by the following time-saving measures: reading electronically readable key codes with an access control module at the entrance of the hotel room unit; a verification process without requiring intervention by any hotel staff; and hotel room units with a garage door as main entrance, a vehicle parking space immediately behind the garage door as part of the hotel room unit and immediate access of the room space from the vehicle parking space.

### TECHNICAL FIELD

The present invention relates to a hotel facility, a system comprising at least one hotel facility and a booking server, and a method for running a hotel facility.

### BACKGROUND ART

Known are, on the one hand, hotel facilities such as motels where guests park their vehicle on a parking space right in front of their hotel room. The known motels require the guests to register themselves at a reception desk, even if a room has been pre-booked.

Known are, on the other hand, online hotel room booking systems via which users can book hotel rooms online and receive a key code with which they can gain immediate access to the hotel room without having to pass by a hotel reception.

It is a disadvantage of the known hotel facilities and booking systems that the process between a guest arriving at the hotel/motel and entering the booked hotel room is not optimized. In particular, in all known cases, there is still a significant time between the moment of arrival at the hotel and the moment at which the guest can go to bed.

### DISCLOSURE OF THE INVENTION

It is an aim of the present invention to provide hotel facilities, systems and methods, with which the time period between a guest arriving at the hotel facility and entering the hotel room, and furthermore the moment at which the guest can go to bed, can be minimised.

This aim is achieved according to the aspects of the invention defined in the independent claims.

According to a first aspect, the invention relates to a hotel facility comprising a plurality of hotel room units and an access control system for controlling access to the hotel room units, wherein each of the hotel room units comprises a garage door forming the main access to the hotel room unit, a vehicle parking space behind the garage door, and a room space adjacent to the vehicle parking space with a passage between the vehicle parking space and the room space, such that the room space is directly accessible from the vehicle parking space; wherein the access control system comprises a plurality of access control modules associated with the garage doors of the hotel room units. Each of the access control modules comprises a key reader device configured for reading a key code provided by a user requesting access to the respective hotel room unit, a processing device communicatively coupled with the key reader device and configured for performing or triggering a verification process for verifying whether the key code read by means of the key reader device matches a valid booking of the respective hotel room unit, and a garage door unlocking and/or opening device communicatively coupled with the processing device and configured for opening the garage door of the respective hotel room unit, wherein the processing device is provided for controlling the garage door unlocking and/or opening device depending on a result of said verification process.

According to the invention, the process of arriving at the hotel facility up to being able to go to bed has been optimized, by means of the following measures which work together in synergy to save time:
the use of electronically readable key codes in combination with the provision of an access control module with key code reader at the entrance of the hotel room unit: this saves time because the key code can be provided to the user beforehand, for example upon confirming the booking; or alternatively in case of use of for example the credit card as key according to embodiments described herein, verification data can be provided to the access control system beforehand;
the provision of the verification process triggered or performed upon detection of the key code, and performed electronically without requiring intervention by any hotel staff: this avoids the need for guest to pass by a reception desk and wait their turn; they can drive directly up to the hotel room unit of their booking;
the garage door as main entrance, operated by the processing device and hence opening almost immediately upon presenting a valid key code;
the vehicle parking space immediately behind the garage door and as part of the hotel room unit: the user does not have to find a parking space in a parking lot of the hotel facility, the user does not have to unload luggage (or only a minimal amount) as he can park his vehicle in a part of his hotel room and decide to leave the luggage in the vehicle and still have it close at hand;
the immediate access of the room space from the vehicle parking space: the user does not have to walk through hallways, take an elevator etc. before he is able to enter his hotel room.

Furthermore, the hotel room units according to the invention have the advantage that the guests can park their vehicle in a safe and private area which is in principle not accessible to others.

In general, the access control module can be embodied as any module or combination of devices having (i) components for receiving a key code from a user, preferably in an electronic way such as by scanning, optic reading or short range communication; (ii) components enabling a verification of the key code, either on the module itself or via communication with a server configured for performing such verification, to verify whether the key code matches a valid booking and access to the hotel room unit should be allowed or denied and (iii) components for allowing access in case of a positive result of the verification by unlocking and/or opening the garage door.

In embodiments according to the invention, the key reader device of the access control modules may for example comprise the following: a credit card terminal or reader, a device provided for reading or scanning QR codes, barcodes or like codes containing a key code, a device provided for reading or scanning key codes in mobile terminals via near field communication or the like, or any other key reader device known to the person skilled in the art.

In embodiments according to the invention, the processing device of the access control modules may for example comprise a processor provided with a verification algorithm which is performed in the module itself (offline verification), or a processor provided with a verification algorithm which comprises communication with a server configured for performing the verification of the key code.

In embodiments according to the invention, the garage door unlocking and/or opening device may comprise an electronic lock, provided for simply maintaining the garage door locked or unlocking the garage door under the control of the processing device, so that the user can manually open the garage door after presenting a valid key code, or a motorized device configured for automatically opening the garage door, or any other like device known to the person skilled in the art.

In aspects according to the invention, which may be combined with other aspects described herein though not necessarily, hotel room units are provided with a specific layout or floor plan. In embodiments according to the invention, the hotel room units may be individual units having a closed housing which contains the vehicle parking space and the room space. These individual units may for example be fully constructed at a construction site and transported to the place where the hotel facility is set up, which can for example be at or near a parking lot, such as for example a highway parking lot, but also at or near cities, industrial areas, holiday centres, shopping centres or other locations. So this embodiment has the advantage that hotel facilities can be set up quickly and dynamically. In embodiments according to the invention, for each hotel room unit the room space comprises at least a primary space comprising bedroom facilities and bathroom facilities. At least for some of the plurality of hotel room units, the room space may further comprise a secondary space comprising office facilities (i.e. a workspace) and/or living room facilities (i.e. a sitting area where the guest can relax, watch TV and the like, possibly with kitchen facilities). The primary space is preferably located on a ground floor level of the respective unit, preferably on substantially the same level as the vehicle parking space so the user does not have to mount stairs to enter the room space. If present, the secondary space is preferably located above the passage on an elevated level with respect to the ground floor level, i.e. with a small staircase leading from the primary space to the secondary space, and preferably has large windows to let light in. This layout has the advantage that it can minimize the floor area of the hotel room unit, i.e. the occupied area at the hotel facility. The elevated level is preferably below a ceiling level of the primary space, with the primary and secondary spaces being visually connected, for example through an opening or a glass window. This has the advantage that natural light can enter into the primary space via windows of the secondary space and the visual connection and also that the primary and secondary spaces are no separate rooms, which can enhance the experience of the hotel guests.

In embodiments according to the invention, for each hotel room unit the passage between the vehicle parking space and the room space is preferably a (short) hallway between a bathroom on one side and a technical room on the other side. This also has the advantage that the floorplan of the hotel room unit can be minimized.

In embodiments according to the invention, the hotel facility is a gated facility comprising a main gate and a further access control module at the main gate, configured to allow or deny access to the gated facility depending on whether a user can present a key code that matches a valid booking of one of the hotel room units of the gated facility. This has the advantage that the security of the guests can be further enhanced.

According to a second aspect, which may be combined with other aspects described herein though not necessarily, the invention provides a system comprising at least one hotel facility as described herein in combination with a booking server which implements an online booking system allowing users to book the hotel room units by means of terminals, for example mobile terminals such as smartphones or a credit card terminal at the hotel facility or the hotel room unit. The booking server is configured for communicating at least verification data relating to the bookings to the access control system of the at least one hotel facility. This verification data can be sent at the time the booking is made and confirmed to the user, or as part of the verification process, multiple embodiments of which are described herein. The provision of the online booking system can provide a quick and easy way to book the hotel room units, which is especially advantageous in the case of last-minute bookings.

In embodiments according to the invention, the booking server may be provided for communicating the verification data to the access control system together (i.e. around the same time) with communicating a booking confirmation to the terminal from which the booking is performed (or which the user has selected or indicated during the booking process). The access control system may be configured for performing the verification process offline, i.e. on the basis of the received verification data without further communication with the booking server. The access control system may also be configured for performing the verification process online, which involves communication with the booking server to determine if access should be allowed or denied.

In embodiments according to the invention, the access control system may require the key code in combination with an additional credential (such as for example a credit card number or other). In such embodiments, the verification process is provided for verifying whether the key code read by means of the key reader device and the additional credential together match a valid booking of the respective hotel room unit. In such embodiments, the security of the guests can be enhanced.

In embodiments according to the invention, the online booking system implemented on the booking server may be configured to reserve a subset of the hotel room units at each of the hotel facilities for last-minute bookings. This means that a first set of the hotel room units at a given hotel facility are available for advance booking at any time whereas a second set of the hotel room units at that hotel facility are only available for booking from a certain point in time. This way it can be assured that there are always a number of hotel room units available for users who have a last-minute need for a place to sleep or rest.

In a third aspect, which may be combined with other aspects described herein though not necessarily, the invention provides a method, in particular a method of running a hotel facility, wherein the time period from the moment of a guest arriving at the hotel facility and the moment of the guest entering his hotel room is minimized by the following steps:

(i) providing at the hotel facility a plurality of hotel room units, wherein each of the hotel room units comprises a garage door forming the main access to the hotel room unit, a vehicle parking space immediately behind the garage door, and a room space adjacent to the vehicle parking space with a passage between the vehicle parking space and the room space, such that the room space is directly accessible from the vehicle parking space;

(ii) providing an access control system for controlling access to the hotel room units, the access control system comprising a plurality of access control modules associated with the garage doors of the hotel room units; and

(iii) controlling access to the hotel room units by means of the access control modules.

The access control procedure comprises: a key reader device of the respective access control module reading a key code provided by a user requesting access to the respective hotel room unit; a processing device of the respective access control module and communicatively coupled with the key reader device performing or triggering a verification process for verifying whether the key code read by means of the key reader device matches a valid booking of the respective hotel room unit; and the processing device controlling a garage door unlocking and/or opening device of the respective access control module, depending on a result of said verification process.

Advantages and embodiments of the method according to the invention are described elsewhere in the present disclosure.

### BRIEF DESCRIPTION OF THE DRAWINGS

The invention will be further elucidated by means of the following description and the appended figures.

FIG. 1 shows a schematic overview of a first embodiment of a system according to the invention.

FIG. 2 schematically shows an embodiment of an access control module of a system according to FIG. 1.

FIG. 3 schematically shows another embodiment of an access control module of a system according to FIG. 1.

FIG. 4 shows flowcharts of embodiments of booking, access control and key code verification algorithms according to the invention.

FIGS. 5 and 6 show view of an embodiment of a hotel room unit according to the invention.

FIG. 7 shows a schematic overview of another embodiment of a system according to the invention, comprising a gated hotel facility.

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

Furthermore, the various embodiments, although referred to as “preferred” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present invention, the only enumerated components of the device are A and B, and further the claim should be interpreted as including equivalents of those components.

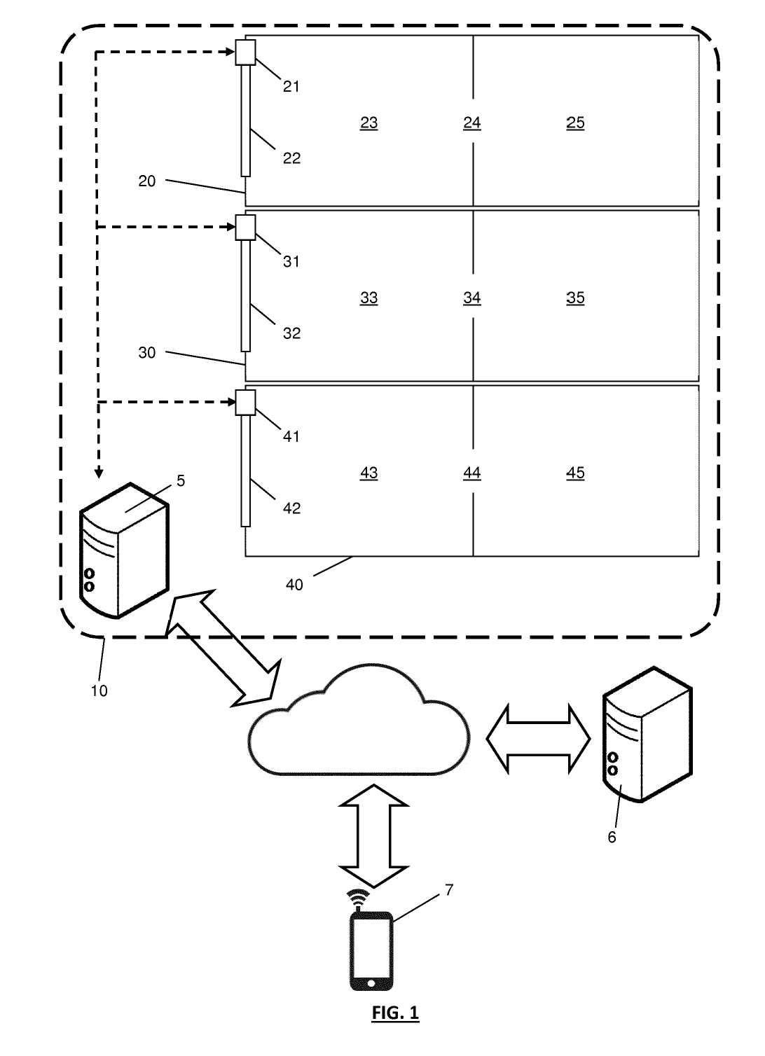

FIG. 1 shows a schematic overview of a first embodiment of a system according to the invention. The system of FIG. 1 comprises a hotel facility 10, comprising a plurality of hotel room units 20, 30, 40 and an access control system 5, 21, 31, 41 for controlling access to the hotel room units. The hotel room units 20, 30, 40 each comprise a garage door 22, 32, 42 forming the main access to the hotel room unit, a vehicle parking space 23, 33, 43 immediately behind the garage door, i.e. the garage door opens to the vehicle parking space, and a room space 25, 35, 45 adjacent to the vehicle parking space with a passage 24, 34, 44 leading directly from the vehicle parking space to the room space, i.e. the room space is directly accessible from the vehicle parking space.

The hotel room units 20, 30, 40 are preferably closed units with the vehicle parking space and the room space inside the walls of the units. The room space comprises at least bedroom facilities and bathroom facilities, possibly also an office space and/or a relaxing space. The hotel facility 10 may have a plurality of units which are all substantially the same, but also smaller and larger units with extra facilities and the like. Embodiments of the hotel room units will be described further below.

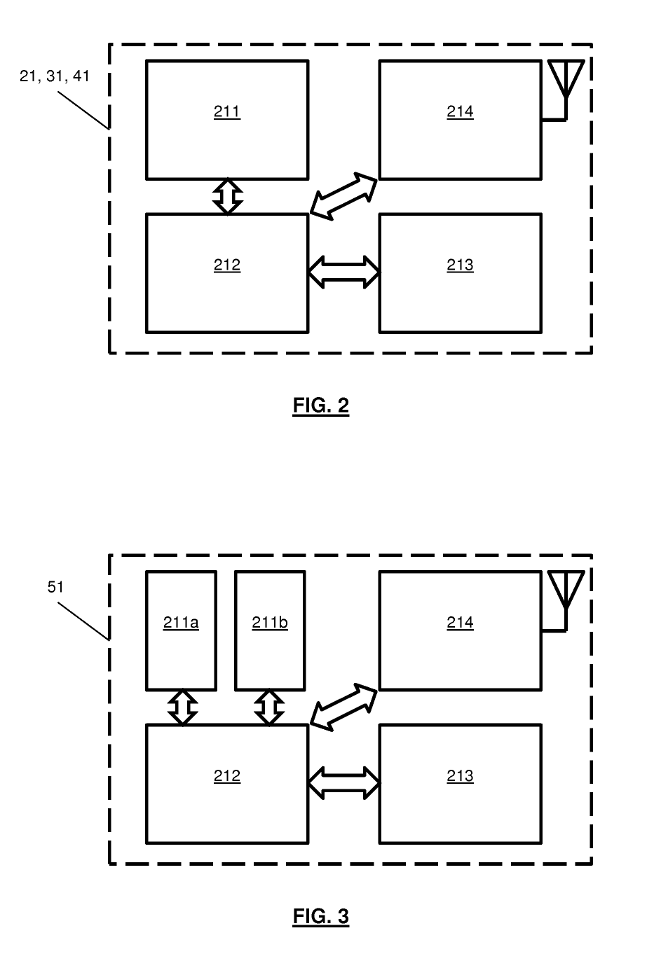

FIG. 2 schematically shows an embodiment of an access control module 21, 31, 41, the access control module being shown in dashed lines as it can be a combination of devices. The module comprises an electronic key reader device 211 configured for reading a key code provided by a user requesting access to the respective hotel room unit. The module further comprises a processing device 212 that is communicatively coupled with the key reader device 211 and is configured for performing or triggering, upon detection of a key code being read, a verification process for verifying whether the key code read by means of the key reader device matches a valid booking of the respective hotel room unit. The module further comprises a garage door unlocking and/or opening device 213 communicatively coupled with the processing device 212 and configured for opening the garage door 22, 32, 42 of the respective hotel room unit 20, 30, 40, wherein the processing device 212 is provided for controlling the garage door device 213 depending on a result of said verification process. The access control module further comprises a communication device 214 configured for enabling the communication with the access control server 5.

In embodiments according to the invention, the key reader device 211 of the access control modules 21, 31, 41 may for example comprise the following: a credit card terminal or reader, a device provided for reading or scanning QR codes, barcodes or like codes containing a key code, a device provided for reading or scanning key codes in mobile terminals via near field communication or the like, or any other key reader device known to the person skilled in the art. Such key reader devices are known per se and are hence not further explained herein for the sake of brevity.

In embodiments according to the invention, the processing device 212 of the access control modules 21, 31, 41 may for example comprise a processor provided with a verification algorithm which is performed in the module itself (offline verification), or a processor provided with a verification algorithm which comprises communication with a server configured for performing the verification of the key code. Processing devices are known per se and are hence not further explained herein for the sake of brevity. Embodiments of the verification process are described further below.

In embodiments according to the invention, the garage door unlocking and/or opening device 213 may comprise an electronic lock, provided for simply maintaining the garage door locked or unlocking the garage door under the control of the processing device, so that the user can manually open the garage door after presenting a valid key code, or a motorized device configured for automatically opening the garage door, or any other like device known to the person skilled in the art. Such garage door unlocking and/or opening devices are known per se and are hence not further explained herein for the sake of brevity.

In embodiments according to the invention, the communication device 214 of the access control modules 21, 31, 41 may comprise any modem configured for wired or wireless communication. In embodiments, the communication device 214 may be or be integrated with a general communication device of the hotel room unit which further provides telecommunication services to the guest, such as TV, internet etc. Such communication devices are known per se and are hence not further explained herein for the sake of brevity.

The access control system 5, 20, 30, 40 is conceived to enable quick access to one of the hotel room units and to avoid the need for intervention by hotel staff, so that the time lapse between a guest arriving at the hotel and entering his hotel room can be minimised. To this end, the access control system generally has components for reading an key code, which is presented by the guest, subsequently enabling a verification whether the presented key code matches a valid booking of the respective hotel room unit and subsequently, allowing or denying access to the hotel room unit depending on the verification, by unlocking and possibly also opening the garage door.

In the embodiment shown in FIG. 1, the access control system comprises an access control server 5, which can for example be a general purpose computer or server system equipped with appropriate software, and access control modules 20, 30, 40, which are communicatively connected to each other as shown by the dashed arrows. The access control server 5 is provided for communicating over the internet with a booking server 6, which can for example also be a general purpose computer or server system equipped with appropriate software. The booking server is provided for communicating over the internet with user terminals, e.g. mobile terminals 7 and implements an online booking system, which enables a user to book hotel room units 20, 30, 40 at one or more hotel facilities 10 and provides the user with key codes, readable by means of the access control modules 20, 30, 40 and provided to allow access if a valid booking is made. The key code can for example be a QR code, bar code or the like that is transmitted from the booking server 6 to the mobile terminal 7, for example incorporated in an email or other electronic message with which the booking is confirmed to the user, or stored in an app provided on the mobile terminal 7. Upon arrival at the hotel facility 10, the user then simply drives his car up to the hotel room unit 20, 30 or 40 that corresponds to his booking, displays the code on his mobile terminal 7 and presents it to the access control module 21, 31 or 41, which will perform or trigger a verification process to verify whether access should be allowed or denied, without requiring presence or intervention of any hotel staff.

The key code may be embodied in many ways. For example, the key codes may be QR codes, barcodes or the like which can be printed on a paper ticket or displayed on the screen of a mobile terminal and optically scanned by an optical reader in the access control module. In another example, in the case the mobile terminal is an NFC (Near Field Communication) enabled smartphone or the like, the key code may be an NFC code provided on the NFC enabled smartphone which is provided for short range transmission to the access control module, also NFC enabled in this case. These technologies are known per se and are hence not further explained herein for the sake of brevity.

The key code used in the system according to the invention may also be simply a credit card. In this embodiment, the access control module may be provided with a credit card terminal or reader or the like. In the case of an advance booking, the credit card is then associated with the booking made by means of the online booking system, so that the credit card effectively becomes the electronic key by which the user can access the booked hotel room unit. Alternatively, in the case no advance booking was made, the user presenting himself at a vacant hotel room unit can book the hotel room unit on the spot by means of his credit card. In this embodiment, the hotel room units are preferably provided with a display to indicate to users whether the hotel room unit is “vacant” or “not vacant”.

In embodiments according to the invention, the online booking system implemented on the booking server 6 may be configured to reserve a number of the hotel room units 20, 30, 40 at the hotel facility 10 for last-minute bookings. This means that a first set of the hotel room units at the hotel facility may be available for advance booking at any time whereas a second set of the hotel room units at the hotel facility may be only available for booking from a certain point in time. This point in time can for example be from 00:00 hrs on the same day or the day before, so that these units can only be booked maximum 24 hrs or 48 hrs in advance. It is evident that this time period can also be chosen shorter or longer, or even varied for example according to the time of the year, or expectations, or the like. Also the number of hotel room units that are reserved for last-minute bookings may be a parameter that can be set in the system and varied for example according to the time of the year, or expectations, or the like. The advantage of reserving a subset for last-minute bookings is that it can be assured that there are always a number of hotel room units available for users who have a last-minute need for a place to sleep or rest, for example users who are tired after a meeting or a long drive, users who had too much to drink etc. Similarly, the online booking system may be configured to allow reservations of hotel room units for shorter time periods, for example a few hours, for example a time period suitable for recharging an electric car.

The verification process can be embodied in many ways. In an embodiment, which can be implemented on the system of FIG. 1, the verification process may be performed “offline”, entirely on the access control system, comprising access control server 5 and access control modules 21, 22, 23. In this embodiment, when a valid booking is made, the booking server 6 sends a notification to the access control server 7, the notification comprising verification data by means of which the verification can be made. When the user the user presents himself at the hotel room unit 20, 30 or 40 corresponding to the booking and provides the matching key code, which can be any form of key code as described elsewhere herein, for reading by the reader device of the access control module 21, 31 or 41. Upon detecting the key code, the processing device triggers a verification algorithm in which it communicates with the access control server 5 to verify whether the key code read matches a valid booking and access should be allowed or denied. If allowed, the processing device operates the garage door locking and/or opening device to unlock and/or open the garage door. In an alternative embodiment, also “offline”, the verification process may entirely take place in the access control module 21, 31 or 41, in which case the verification data is forwarded from the access control server 5 to the module or may even be sent directly from the booking server 6 to the module 21, 31 or 41 if the latter is internet enabled, i.e. itself configured for preferably secure communication over the internet.

In other embodiments, the verification process may be “online”, meaning that the detection of the key code triggers a verification algorithm in which the access control module 21, 31, 41 and/or the access control server 5 communicates with the booking server to verify whether the key code presented by the user matches a valid booking of the respective hotel room unit 20, 30, 40.

The “offline” verification processes have the advantage that no internet link is needed at the time of the verification, which may speed up the verification process and avoid that no verification is possible during downtime of the internet or the booking server. The “online” verification processes, on the other hand, have the advantage that always the latest status of the system can be checked, for example if the booking of the respective hotel room unit has in the meantime been cancelled for any reason or, in case of no pre-booking, if the respective hotel room unit has in the meantime been booked by another, or the like. In other embodiments, “online” and “offline” verification processes may be combined in hybrid systems, with for example a preference for “online” verification if available and “offline” verification as a fall-back if the “online” verification is not possible for whatever reason.

In further embodiments, the access control system may be embodied such that the system requires the key code in combination with an additional credential before allowing access to the booked hotel room unit. One example of such an embodiment is a key code transmitted to the user's mobile terminal 7 by the booking server 6 as described above, together with the credit card number used to pay for the booking. In this embodiment, the access control modules 51 of the access control system, an example of which is shown in FIG. 3, comprise both a credit card reader 211a and a key code reader 211b configured for reading the key code on the mobile terminal 7; and the verification process comprises steps for verifying whether the read key code and the credit card number both match the booking of the respective hotel room unit. Many other combinations of the key code with another credential can be conceived within the scope of the present invention.

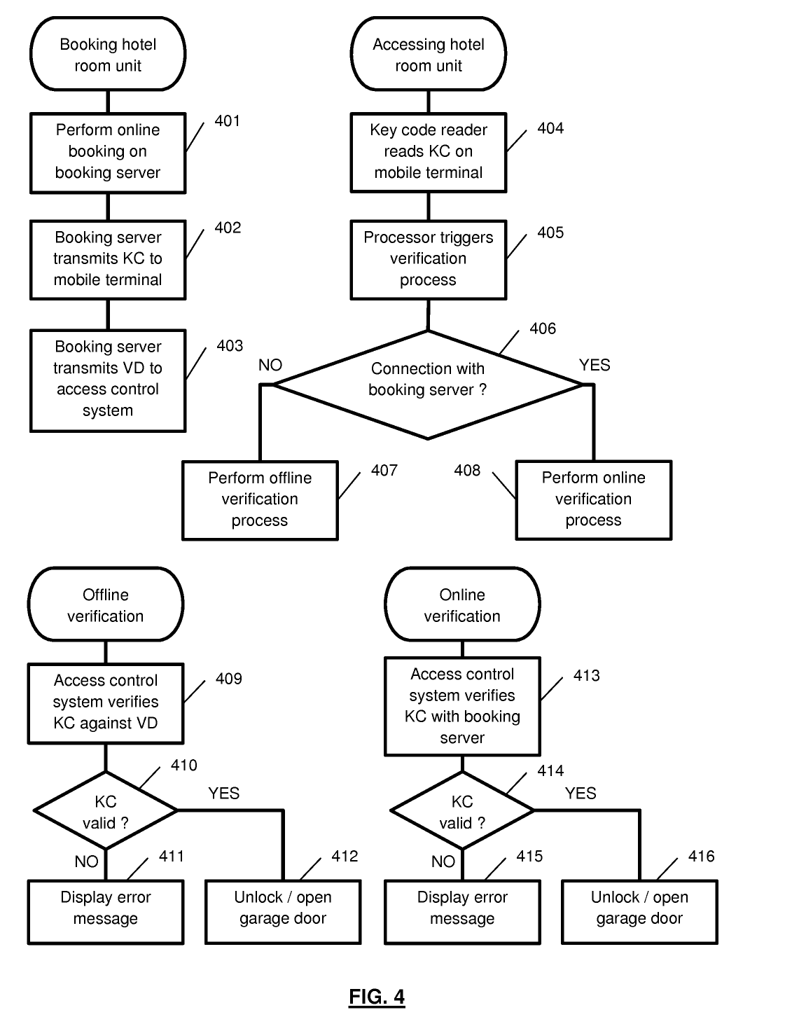

FIG. 4 shows flowcharts of embodiments of booking, access control and key code verification algorithms according to the invention. The booking algorithm comprises steps 401-403 and can be performed by means of the booking server 6, a mobile terminal 7, and an access control system 5 as shown in FIG. 1. At step 401, an online booking is performed by a user on the booking server, for example using his mobile terminal. At step 402, upon completion of the booking, the booking server transmits a key code (abbreviated “KC”) to the mobile terminal, for example as part of a message with which the booking is confirmed. At step 403, which may be performed around the same time as step 402, the booking server transmits verification data (abbreviated “VD”) to the access control system, to enable verification of KC at the hotel premises. In alternative embodiments, for example if a credit card number is associated with the booking for use as a key to access the booked hotel room, step 402 may be omitted (the credit card number then being KC). In other alternative embodiments, for example if the verification process is to be performed always online in communication with the booking server, step 403 may be omitted. In still other embodiments, a dual verification may be performed which comprises both the association of a credit card number and a KC to the booking, the KC then being sent to the mobile terminal and the access control comprising reading both the KC (from the mobile terminal) and the credit card number (by insertion of the card in the reader).

The process for accessing the booked hotel room unit comprises the steps 404-408. At step 404, KC is read by means of the key card reader of the access control module of the hotel room unit where the user presents himself. Upon detection of a KC being read, the processor of the respective access control module triggers a verification process, step 405. In this embodiment, the access control system first looks for a connection with the booking server, step 406, and the access control system is configured for performing the verification online if a connection with the booking server is present, step 408, and offline if no such connection is present, step 407.

The offline verification process comprises steps 409-412. At step 409, the access control system verifies KC against VD, to check whether the KC presented in step 404 matches a booking of the respective hotel room unit at that time. This verification yields a result in step 410. If KC is not valid, i.e. the verification result is negative, the garage door is kept locked or closed and the processing device may for example instruct to display an error message on a display of the access control module, step 411. If KC is valid, i.e. the verification result is positive, then the processing device of the respective access control module will instruct the garage door device to unlock or open the garage door, step 412.

The online verification process comprises steps 413-416. At step 413, the access control system verifies KC in communication with the booking server. This can for example comprise a transmission of KC to the booking server, which simply returns a verification result, or a request to the booking server to send data to enable the verification on the access control system. This verification yields a result in step 414. If KC is not valid, i.e. the verification result is negative, the garage door is kept locked or closed and the processing device may for example instruct to display an error message on a display of the access control module, step 415. If KC is valid, i.e. the verification result is positive, then the processing device of the respective access control module will instruct the garage door device to unlock or open the garage door, step 416.

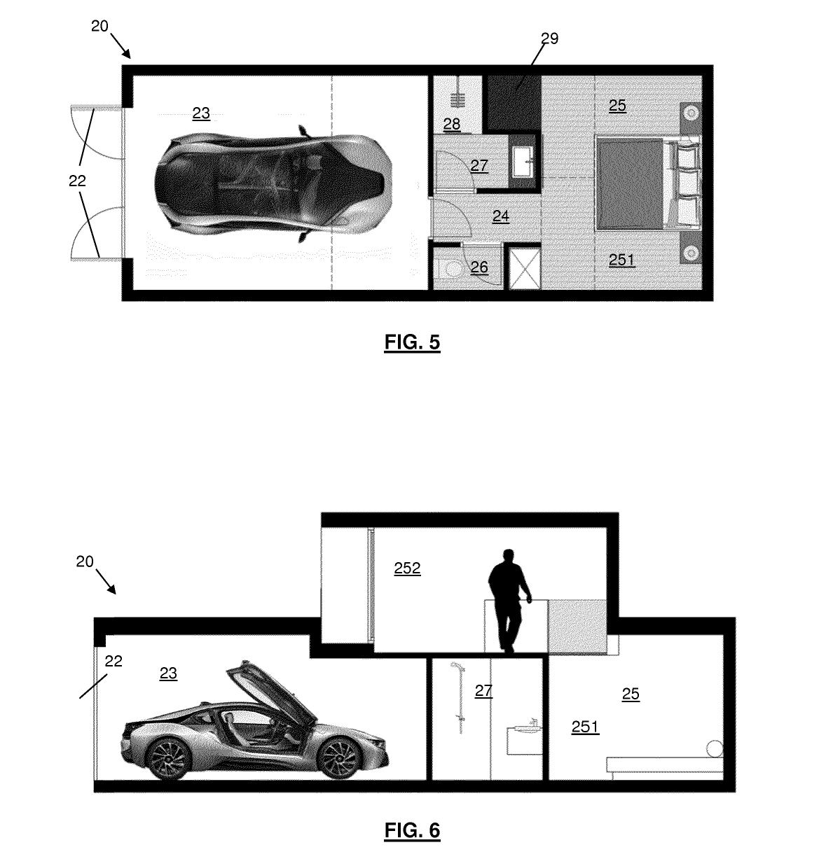

FIGS. 5 and 6 show views of an embodiment of the hotel room unit. As shown, the units can be individual units having a closed housing which contains the vehicle parking space 23 and the room space 25. These individual units may for example be fully constructed at a construction site and transported to the place where the hotel facility is set up, which can for example be at or near a parking lot, such as for example a highway parking lot, but also at or near cities, industrial areas, holiday centres, shopping centres or other locations. A plurality of them may be placed side by side, as shown in FIG. 1, with an access control server 5 to locally monitor the access to the individual units.

The hotel room unit 20 shown in FIGS. 5 and 6 comprises a garage door 22, a vehicle parking space 23 immediately behind the garage door and a room space 25 behind the vehicle parking space, with a passage 24 leading from the vehicle parking space to the room space. The garage door 22 has two parts, a first part which folds to one side and a second part which hinges to the other side and forms also a door which can be opened separate from the first part. It is clear that any other garage door may also be used according to the invention. The garage door 22 provides the main access to the hotel room unit 20 and in the embodiment with the first and second parts as shown there is thus a door part which can be opened by users without having to open the complete garage door, which is for example convenient for servicing personnel. The garage door may be the only user access to the hotel room unit.

The vehicle parking space 23 may be equipped with a charge point for charging electric vehicles. This can be advantageous as the hotel room unit can then also be rented for shorter periods, for example a number of hours sufficient for recharging a vehicle while the user has a private place to rest or work.

The room space 25 comprises a primary space 251 comprising bedroom facilities and bathroom facilities, in fact a bedroom space 251 and a toilet 26 and bathroom 27 on opposite sides of the passage 24. The unit further has a technical room 28 and a small staircase 29. The room space further comprises a secondary space 252 which may comprise office facilities (i.e. a workspace) and/or living room facilities (i.e. a sitting area where the guest can relax, watch TV and the like, possibly with kitchen facilities). The primary space 251 is located on the ground floor level of the respective unit, so on substantially the same level as the vehicle parking space so the user does not have to mount stairs to enter the room space. As shown, the secondary space 252 is located above the passage on an elevated level with respect to the ground floor level, i.e. with a small staircase 29 leading from the primary space to the secondary space, and has large windows to let light in. This layout has the advantage that it can minimize the floor area of the hotel room unit, i.e. the occupied area at the hotel facility. As shown, the elevated level is somewhat below a ceiling level of the primary space, with the primary and secondary spaces being visually connected. This has the advantage that natural light can enter into the primary space via the windows of the secondary space and the visual connection. Also, the primary and secondary spaces are no separate rooms, which can enhance the experience of the hotel guests.

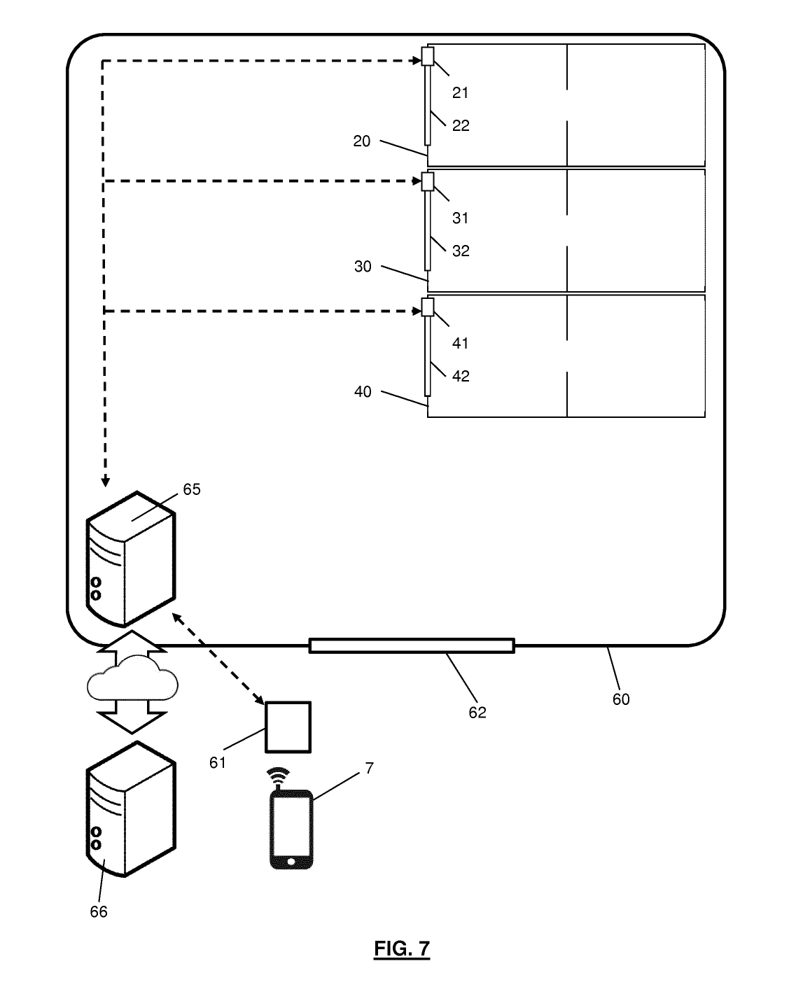

A plurality of hotel room units as shown in FIGS. 5 and 6 may form part of a gated community, an example of which is shown in FIG. 7. The gated or walled hotel facility 60 comprises a main gate 62 and a further access control module 61 at the main gate, configured to allow or deny access to the gated facility depending on whether a user can present a key code that matches a valid booking of one of the hotel room units of the gated facility. This means that at the main gate, the key code is read a first time, which triggers a first verification in which it is verified if the key code matches a valid booking of one of the hotel room units 20, 30, 40 of that facility 60, and that subsequently the key code is read a second time when the user presents himself at one of the hotel room units 20, 30, 40, in the same way as described elsewhere herein. In such a gated hotel facility 60, the security of the guests can be further enhanced as access to the facility by unauthorised users can be prevented.

In particular, in the gated hotel facility 60, the guest arriving at the hotel facility first presents the key code, which as shown can for example happen by near field communication with the main access control module 61, but may also be embodied in the same way as has been described above. This main access control module may be highly similar to the ones at the hotel room units that have already been described above and is therefore not described in great detail for the sake of brevity. The main access control module may likewise comprise a key reader device, a processing device with communication device enabling communication with access control server 65, and a gate opening device which can open the main gate 62. The detection of the key code being read may likewise trigger a verification algorithm or process which may involve access control server 65 and even booking server 66 and result in opening the main gate 62 if the key code matches a valid booking at the gated hotel facility 60.

As shown the access control module 61, or at least the key reader device thereof, may be placed a distance in front of the main gate 62 so that the user can present his key code without having to exit his vehicle. The same is valid for the access control modules 21, 31, 41 of the hotel room units 20, 30, 40.

In embodiment according to the invention, a local booking system may be provided, possibly in combination with the online booking system as described herein, comprising a terminal where a user can locally book one of the hotel room units, which involves a payment for example by credit card or other known payment systems at the terminal and result in the terminal outputting a ticket on which the key code is printed. The user can then subsequently gain access to the hotel room unit of his booking by presenting the ticket to the key reader device of the respective access control module.

1. A hotel facility comprising a plurality of hotel room units and an access control system for controlling access to the hotel room units, wherein
each of the hotel room units comprises a garage door forming the main access to the hotel room unit, a vehicle parking space immediately behind the garage door, and a room space adjacent to the vehicle parking space with a passage between the vehicle parking space and the room space, such that the room space is directly accessible from the vehicle parking space;
the access control system comprises a plurality of access control modules associated with the garage doors of the hotel room units, each of the access control modules comprising:
a key reader device configured for reading a key code provided by a user requesting access to the respective hotel room unit;
a processing device communicatively coupled with the key reader device and configured for performing or triggering a verification process for verifying whether the key code read by means of the key reader device matches a valid booking of the respective hotel room unit; and
a garage door unlocking and/or opening device communicatively coupled with the processing device and configured for opening the garage door of the respective hotel room unit, wherein the processing device is provided for controlling the garage door unlocking and/or opening device depending on a result of said verification process.

2. The hotel facility according to claim 1, wherein the hotel room units are individual units having a closed housing which contains the vehicle parking space and the room space.

3. The hotel facility according to claim 2, wherein for each hotel room unit the room space comprises at least a primary space comprising bedroom facilities and bathroom facilities, and wherein for at least some of the plurality of hotel room units, the room space further comprises a secondary space comprising office facilities and/or living room facilities.

4. The hotel facility according to claim 3, wherein the primary space is located on a ground floor level of the respective unit, and wherein the secondary space is located above the passage on an elevated level with respect to the ground floor level.

5. The hotel facility according to claim 4, wherein the elevated level is below a ceiling level of the primary space and wherein the primary and secondary spaces are visually connected.

6. The hotel facility according to claim 1, wherein for each hotel room unit, the passage is a hallway between a bathroom on one side and a technical room on the other side.

7. The hotel facility according to claim 1, wherein the hotel facility is a gated facility comprising a main gate and a further access control module at the main gate, configured to allow or deny access to the gated facility depending on whether a user can present a key code that matches a valid booking of one of the hotel room units of the gated facility.

8. A system comprising at least one hotel facility according to claim 1 and a booking server, wherein the booking server implements an online booking system allowing users to book the hotel room units by means of terminals and wherein the booking server is configured for communicating at least verification data relating to said bookings to the access control system of the at least one hotel facility.

9. The system according to claim 8, wherein the booking server is provided for communicating the verification data to the access control system together with communicating a booking confirmation to the terminal from which the booking is performed and wherein the access control system is configured for performing the verification process offline without communicating with the booking server.

10. The system according to claim 8, wherein the access control system is configured for performing the verification process online, which involves communication with the booking server.

11. The system according to claim 8, wherein the access control system requires the key code in combination with an additional credential and wherein the verification process is provided for verifying whether the key code read by means of the key reader device and the additional credential together match a valid booking of the respective hotel room unit.

12. The system according to claim 8, wherein the online booking system implemented on the booking server is configured to reserve a subset of the hotel room units at each of the hotel facilities for last-minute bookings.

13. A method of running a hotel facility, wherein the time period from the moment of a guest arriving at the hotel facility and the moment of the guest entering his hotel room is minimized by the following steps:
providing at the hotel facility a plurality of hotel room units, wherein each of the hotel room units comprises a garage door forming the main access to the hotel room unit, a vehicle parking space immediately behind the garage door, and a room space adjacent to the vehicle parking space with a passage between the vehicle parking space and the room space, such that the room space is directly accessible from the vehicle parking space;
providing an access control system for controlling access to the hotel room units, the access control system comprising a plurality of access control modules associated with the garage doors of the hotel room units; and
controlling access to the hotel room units by means of the access control modules, which comprises:
a key reader device of the respective access control module reading a key code provided by a user requesting access to the respective hotel room unit;
a processing device of the respective access control module and communicatively coupled with the key reader device performing or triggering a verification process for verifying whether the key code read by means of the key reader device matches a valid booking of the respective hotel room unit; and
the processing device controlling a garage door unlocking and/or opening device of the respective access control module, depending on a result of said verification process.

14. The method according to claim 13, further comprising the step of, in case of an advance booking of one of the hotel room units, communicating verification data from a booking server to the access control system, such that the verification process can be performed offline.

15. The method according to claim 13 wherein the verification process is performed online, which involves communication with a booking server.

16. The method according to claim 13, wherein the key code that is read is one of the following: a credit card number, a QR code, a barcode, a key code transmitted from a mobile terminal via near field communication.

17. The method according to claim 13, wherein the access control system requires the key code in combination with an additional credential and wherein the verification process verifies whether the key code read by means of the key reader device and the additional credential together match a valid booking of the respective hotel room unit.

18. The method according to claim 13, further comprising the step of providing an online booking system and reserving in the online booking system a subset of the hotel room units at the hotel facility for last-minute bookings.
